(19) United States
(12) Patent Application Publication
(10) Pub. No.: US 2010/0132010 A1
(43) Pub. Date: May 27, 2010

(54) IMPLEMENTING POLICIES IN RESPONSE TO PHYSICAL SITUATIONS

(75) Inventors: Deon J. Chatterton, Livermore, CA (US); Shmuel Shaffer, Palo Alto, CA (US)

Correspondence Address: SCHWEGMAN, LUNDBERG & WOESSNER, P.A., P.O. BOX 2938, MINNEAPOLIS, MN, 55402, US

(73) Assignee: Cisco Technology, Inc., san jose, CA (US)

(21) Appl. No.: 12/323,278

(22) Filed: Nov. 25, 2008

(51) Int. Cl. H04L 9/00

(52) U.S. Cl. 726/1

(57) ABSTRACT

A method and apparatus is described to implement policies associated with physical situations (e.g., supply of power, occurrence of a fire, etc.). The method may comprise accessing sensor data captured by a sensor monitoring a physical situation to identify at least one activity occurring during the physical situation. A policy database including a plurality of policies may be accessed to identify at least two lower-level policies associated with the physical situation. Further, the policy database may be accessed to identify at least one higher-level policy associated with the physical situation. The higher-level policy may control implementation of the at least two lower-level policies.

### FIELD

The present disclosure relates generally to policies implemented in response to physical situations.

### BACKGROUND

A policy management system may have a database including a plurality of policies. Physical situations (e.g., supply of power, occurrence of a fire, etc.) may occur when more than one policy is active. Accordingly, one active policy may drain resources (e.g., consumption of limited electrical power) that would be more beneficially reserved for another policy.

### BRIEF DESCRIPTION OF DRAWINGS

Embodiments are illustrated by way of example, and not limitation, in the figures of the accompanying drawings, in which like references indicate similar elements and in which:

FIG. 1 depicts a simplified diagram of a system, in accordance with an example embodiment, to implement policies in response to activities occurring during real-time events;

FIG. 2 depicts a simplified block diagram of an apparatus, in accordance with an example embodiment, to implement policies in response to activities occurring during real-time events;

FIG. 3 depicts a flow diagram of a general overview of a method, in accordance with an example embodiment, for implementing policies in response to activities occurring during real-time events;

FIG. 4 depicts a flow diagram of a general overview of a method, in accordance with an example embodiment, for allowing a user to select a higher-level policy using a single user interaction;

FIG. 5 depicts a simplified policy data record in a policy database, in accordance with an example embodiment, showing multiple higher- and lower-level policies;

FIG. 6 depicts an example nested or hierarchical structure of the policies in the policy data record shown in FIG. 5;

FIG. 7 depicts an example policy data record, in accordance with an example embodiment, in the policy database showing rules and entities associated with the higher- and lower-level policies;

FIG. 8 depicts an example policy data record, in accordance with an example embodiment, in the policy database showing policies associated with sensors;

FIG. 9 depicts an example graphical user interface, in accordance with an example embodiment, in which a sub-set of active policies are displayed; and

FIG. 10 is a simplified block diagram of a machine in the example form of a computing system within which a set of instructions for causing the machine to perform any one or more of the methodologies discussed herein may be executed.

### DESCRIPTION OF EXAMPLE EMBODIMENTS

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to one skilled in the art that embodiments of the inventive subject matter may be practiced without these specific details. In general, well-known instruction instances, protocols, structures and techniques have not been shown in detail.

Overview

A method and apparatus to implement policies associated with physical situations are described. The method may comprise accessing sensor data, captured by a sensor monitoring the physical situation, to identify at least one activity occurring during the physical situation. A policy database including a plurality of policies may be accessed to identify at least two lower-level policies associated with the physical situation. Further, the policy database may be accessed to identify at least one higher-level policy associated with the physical situation. The higher-level policy may control implementation of the at least two lower-level policies.

### Example Embodiments

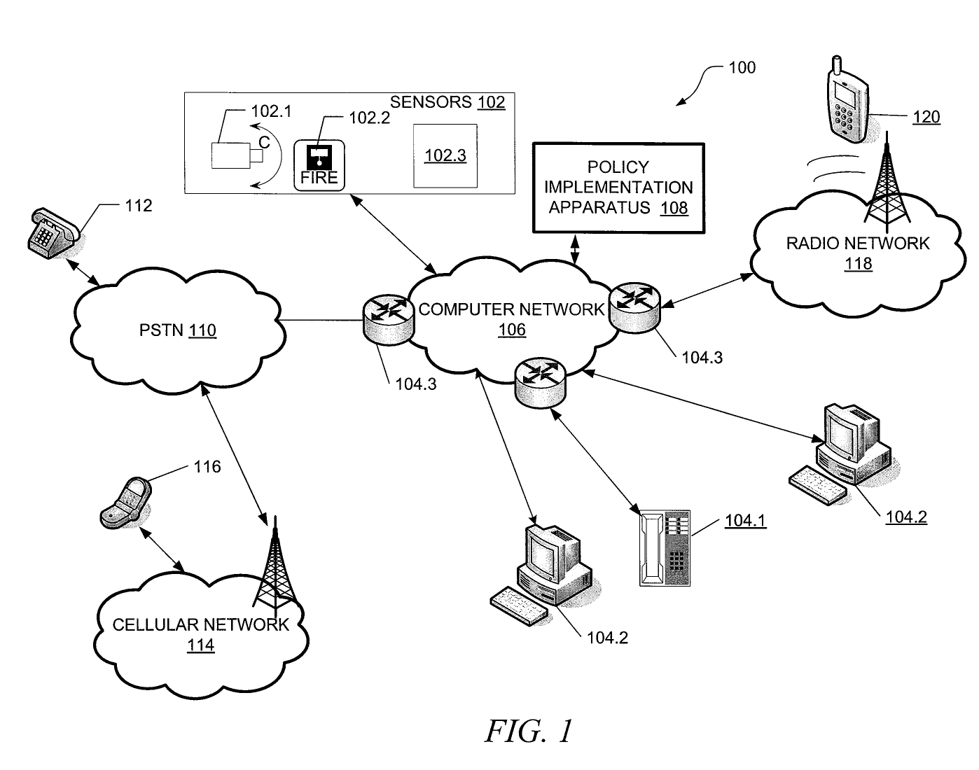

Referring to the drawings, FIG. 1 depicts a simplified diagram of system 100, in accordance with an example embodiment, to implement policies in response to physical situations (e.g., supply of power, occurrence of a fire, or any other physical situation). In an example embodiment, the physical situation may be a real-time event and activities may occur during real-time events. Accordingly, example embodiments are described in the context of a real-time event. However, it is to be noted that this disclosure relates to any physical situation and it not limited to real-time events or activities occurring during real-time events. At least some of the components of the system 100 may be deployed in one or more buildings and, in an example embodiment, are used to control emergency situations. Examples of emergency situations include, but are not limited to, a fire, a power failure where emergency power is required, the failure of networked devices, or the like.

Examples of networked devices include heating, ventilation and air conditioning (HVAC) systems, lighting systems, network enabled elevator systems, entry control points to parking areas, door locking systems, access control systems, or the like. The system 100 may also be used to implement policies for network devices such as routers, switches, servers, personal computers (PCs), telephones, and any other electronic devices connected to, or forming part of, a computer network. As used herein, the term ‘networked device’ is intended to include any electronic/electrical device forming part of, or connected to, a computer network.

The system 100 is shown, by way of example, to include a plurality of sensors 102, a plurality of networked devices 104 including voice over IP (VoIP) telephones 104.1, computers 104.2 (e.g., servers or PCs), routers 104.3, a computer network 106, and a policy implementation apparatus 108. In use, the policy implementation apparatus 108 is configured to implement one or more policies based on data received from the sensors 102. It is important to note that many different network devices may be connected to the computer network 106 and that the VoIP telephones 104.1, the computers 104.2, and the routers 104.3 are shown merely by way of example.

As the system 100 may be used to implement policies in emergency situations, it is also shown by way of example to include connectivity to a public switched telephone network (PSTN) 110 servicing telephones 112, a cellular network 114 servicing mobile phones 116, and a radio network 118 configured to communicate with one or more mobile communication devices (e.g., push-to-talk (PTT) radios 120).

As mentioned above, in an example embodiment, the system 100 may be deployed in a building and the sensors 102 may include video surveillance cameras 102.1 to monitor physical situations (e.g., the presence of persons within the building, a fire, or the like), fire detectors 102.2 to sensors to sense fire, and other sensors 102.3 to sense any other physical situations (e.g., real-time events or activities occurring during real-time events) that may have an associated policy to implement when the physical situation occurs.

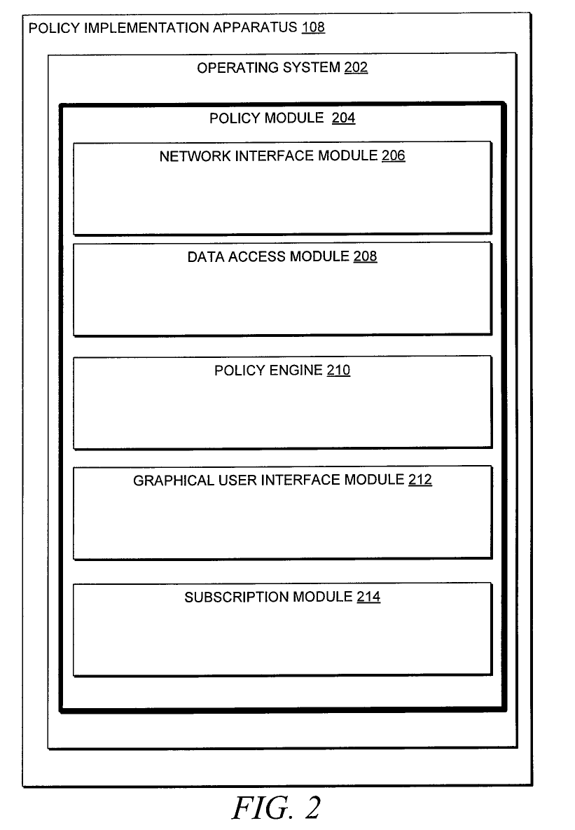

FIG. 2 depicts a simplified block diagram of the policy implementation apparatus 108 shown in FIG. 1. The apparatus 108 includes memory for storing an operating system 202 that, when executed, performs the methodologies described herein. As described in more details blow, the apparatus 108 includes a policy module 204 to identify at least one physical situation (e.g., an activity occurring during a real-time event) and to control implementation of policies in response to the physical situation. Controlling implementation of policies may include whether or not one or more policies are implemented and/or the manner (e.g., how) in which one or more policies are implemented.

As shown in FIG. 2, the policy module 204 may include a network interface module 206, a data access module 208, a policy engine 210, a graphical user interface (GUI) module 212, and, optionally, a subscription module 214. The network interface module 206 is configured to interface the policy implementation apparatus 108 to the computer network 106. In an example embodiment, sensor data may be stored in a database external to the policy implementation apparatus 108. Accordingly, the data access module 208 may be provided to access policy data stored in the external database. The policy engine 210 may process various different commands and rules based on the sensor data and a GUI generated by the GUI interface module 212 may provide various outputs and user inputs. In an example embodiment, entities or devices affected by the various policies that may be managed and implemented by the apparatus 108 may subscribe to a selected policy. The subscription module 214 may manage and control these subscriptions.

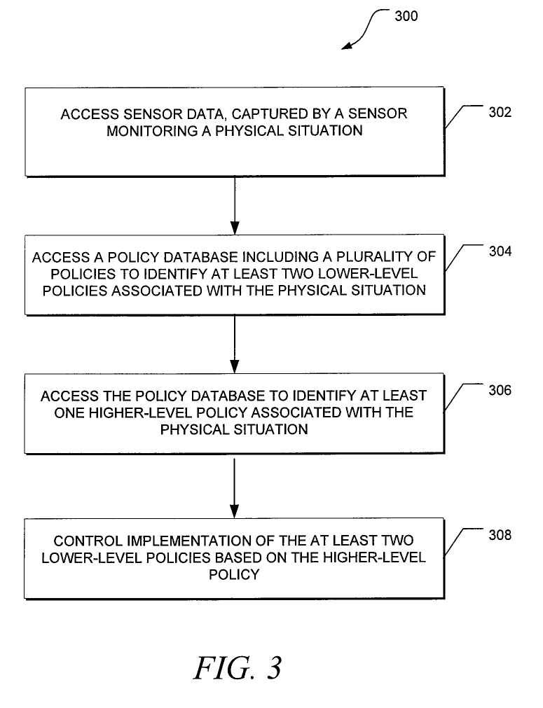

FIG. 3 depicts a flow diagram of a general overview of a method 300, in accordance with an example embodiment, for implementing policies in response to physical situations (e.g., real-time events or activities occurring during real-time events). The method 300 may be performed by the policy implementation apparatus 108 and, accordingly, is described by way of example with reference thereto.

As shown at block 302, the method 300 may access sensor data captured by one or more sensors 102 that monitor a physical situation. In an example embodiment, the method 300 may identify at least one activity occurring during the real-time event. Examples of physical situations include emergency situations such as a fire in a building, a network failure, a power outage, or the like. When the physical situation is a power outage, a power sensor may monitor when there is low power availability from a backup battery system and, as described in more detail below, an associated policy may be executed (e.g., certain network devices may be switched off). As shown at block 304, the method 300 may then access a policy database including a plurality of policies to identify at least two lower-level policies associated with the physical situation. Examples of two lower-level policies include a policy relating to bandwidth allocation on a computer network and a policy relating to an emergency such as a fire. At block 306, the method 300 then accesses the policy database to identify at least one higher-level policy associated with the physical situation. Thereafter, as shown at block 308, implementation of the at least two lower-level policies may be based on the at least one higher-level policy. Returning to the example of the fire emergency and allocation of bandwidth in the computer network 106, the higher-level policy may, when a fire is detected, allocate more bandwidth to video surveillance cameras 102.1 that are located in an area where the fire is detected than to those video surveillance cameras in a different area within a building where no fire has been detected.

In accordance with an example embodiment, the policy module 204 includes a policy that gets automatically implemented upon detection of a power outage. Upon detection of this physical situation, the policy implementation apparatus 108 may cut power to areas that are deemed to have lower power priority. Examples of areas having the lower power priority include, but are not limited to, air-conditioning units, water pumps, network resources, etc. However, if a fire is sensed during a power outage, a fire sub-policy may be activated resulting in a different set of priorities such as resumption of power to network resources which transport video images of the fire. In yet another example embodiment one or more sensors may probe an active server back-up application to inquire about a length of time required to complete a backup. In response to the probe, the policy implementation apparatus 108 may activate a policy where power is still provided to a back-up system, or activate a policy in which the provision of power to the back-up system is terminated. In yet another example embodiment, a two level policy engine may control access rights of various personnel to network resources such as the sensors 102. In accordance with this example embodiment, users may gain or lose access to the network resources based on real-time conditions as reported by real-time sensor information. For example, emergency personnel or a public safety-first responder (PSFR) may not normally have access to video streams from a company's video surveillance cameras. However, upon detection of a fire, a routing policy may be activated that changes access rights of the PSFR has and facilitate streaming of video streams to a network port accessible externally by PSFR personnel.

An administrator using an administrative console may define higher- and lower-level policies. Accordingly, in an example embodiment, the policy implementation apparatus 108 includes the GUI module 212 to generate GUIs to receive input data from a user and to provide output data to the user.

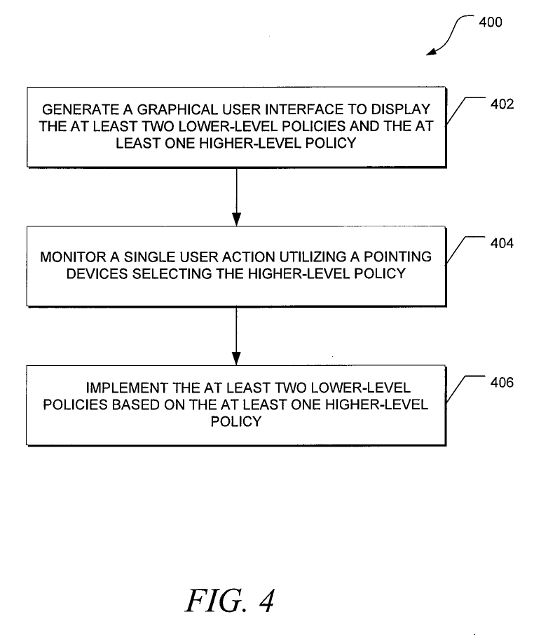

FIG. 4 depicts a flow diagram of a general overview of a method 400, in accordance with an example embodiment, for allowing a user to select a higher-level policy using a single user interaction. In an example embodiment, a user may select a higher-level policy based on a single mouse click. The method 400, as shown at block 402, may generate a GUI to display the at least two lower-level policies and the at least one higher-level policy. It will be appreciated that in example embodiments a number of different policies (higher- and/or lower-level) may be displayed and thus the user may not be restricted to only a few policies.

Thereafter, at block 404, the method 400 may monitor a single user action by a pointing device (e.g., a computer mouse) that identifies that a user has selected the higher-level policy for implementation. As shown at block 406, the policy implementation apparatus 108 may automatically, without any further user interaction, implement the at least two lower-level policies (or any other associated policies) based on the at least one higher-level policy.

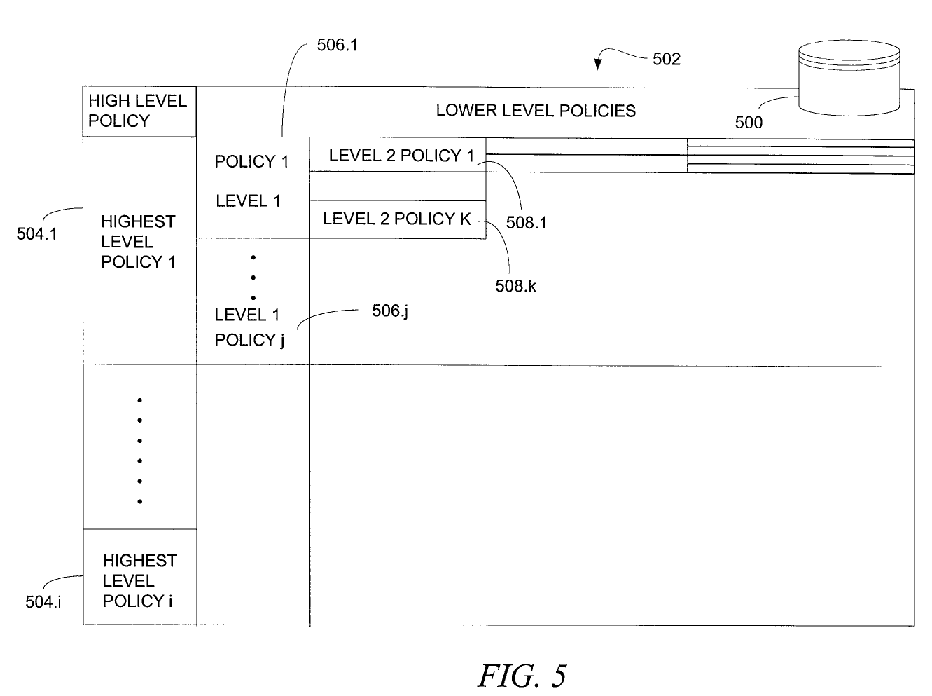

FIG. 5 depicts a simplified policy data record 502, in accordance with an example embodiment, in a policy database showing multiple higher- and lower-level policies. The policy data record 502 is shown to include a plurality of highest level policies 504.1-504.i, wherein each highest level policy 504.1-504.i may have one or more lower-level policies which, in turn, may have one or more lower-level policies, and so on. For example, the highest level policy 504.1 is shown by way of example to include a plurality of level 1 policies 506.1-506.j. In turn, one or more of the level 1 policies 506.1-506.j may include further level 2 policies 508.1-508.k. The level 1 policies 506.1-506.j are considered to be higher-level policies relative to the level 2 policies 508.1-508.k which are lower-level policies (relative to the level 1 policies 506.1-506j. Likewise, the level 2 policies 508.1-508.k would be considered higher-level policies relative to level 3 policies (not shown in FIG. 5).

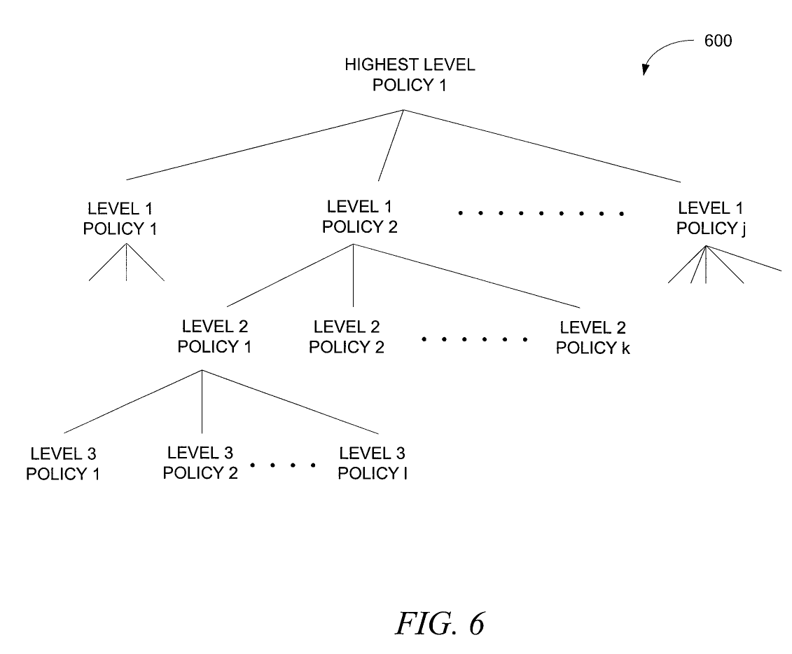

FIG. 6 depicts an example nested or hierarchical structure 600 of the policies in the policy data record 502 shown in FIG. 5. As shown in FIG. 6, a plurality of different levels of policies may be provided in the policy data record 502 wherein, relative to its position in the hierarchical structure 600, a particular policy may be a higher-level policy when compared to a policy in a lower level, or may be a lower-level policy when compared to a policy in a higher level in the hierarchical structure 600. Thus, the data record 502 may define policies that control other policies which, in turn, may control further policies.

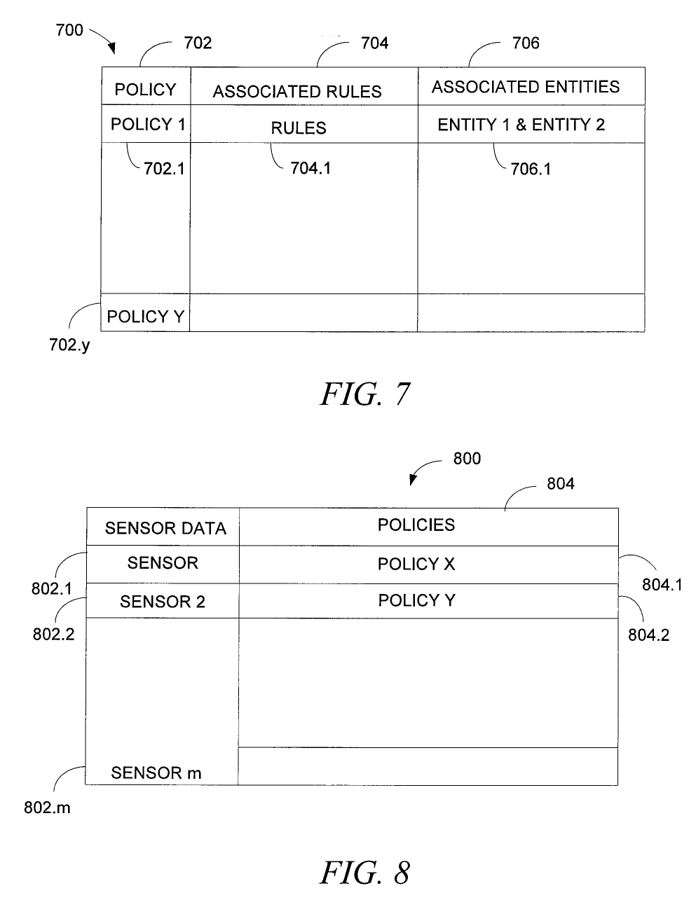

FIG. 7 depicts an example data record 700, in accordance with an example embodiment, in a policy database showing rules and entities associated with the higher- and lower-level policies. Accordingly, the policy data record 700 includes a policy field 702 that includes a plurality of policies 702.1-702.y. Further, the policy data record 700 includes an associated rules field 704 including one or more rules 704.1 that are implemented or cause instructions to be sent when an associated policy (e.g., the policy 702.1) is implemented or is active. The policy data record 700 is shown further to include an associated entities field 706 that identifies one or more entities (e.g., network devices, personnel, or the like) associated with the rules. In the example data record 704, entities 1 and 2 (see 706.1) are shown to be associated with the policy 702.1

FIG. 8 depicts an example policy data record 800, in accordance with an example embodiment, in a policy database showing policies associated with the sensors 102. The policy data record 800 is shown to include a plurality of sensor data fields 802.1-802.m. Associated with each sensor 802.1-802.m is a policy defined in a policies field 804. For example, in the example policy data record 800 shown in FIG. 8, a policy X 804.1 is shown to be associated with a sensor 802.1 and a policy Y 804.2 is shown to be associated with a sensor 802.2. It is to be appreciated that more than one policy may be associated with each sensor and, likewise, more than one sensor 102 may be associated with one or more policies.

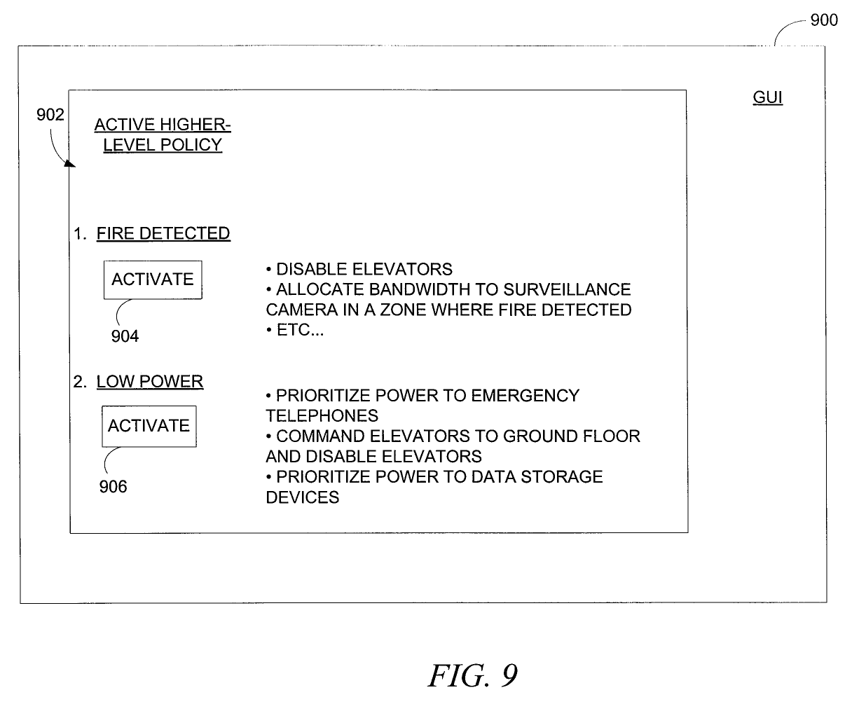

FIG. 9 depicts an example GUI 900, in accordance with an example embodiment, in which a subset of active policies is displayed. The GUI module 212 of the policy implementation apparatus 108 shown in FIG. 2 may generate the GUI 900. Further, the GUI 900 may be generated and used by the methods 300, 400 shown in FIGS. 3 and 4.

The GUI 900 includes a display area 902 to identify active higher-level policies. For example, a fire detection policy and a low power policy are shown as being active. The fire detection policy may include a plurality of sub-policies that are also active. For example, the fire detection higher-level policy is shown to include a disable elevators sub-policy, an allocate bandwidth to a surveillance camera in a zone where a fire is detected sub-policy, and other lower-level policies. Each lower-level policy may include a plurality of rules and instructions with associated entities and commands to effect or implement the policy. By way of further example, a low power higher-level policy is shown to include three lower-level policies. By way of example, the low power higher-level policy is shown to include a prioritize power to emergency telephones policy, a command elevators to ground floor and disable elevators policy, and a prioritize power to data storage devices policy. Each higher-level policy is shown to include a radio button so that an administrator may activate the higher-level policy with a single click or interaction. For example, an “Activate” button 904 is provided to activate the fire detected higher-level policy and an “Activate” button 906 is provided to select and activate a low power higher-level policy.

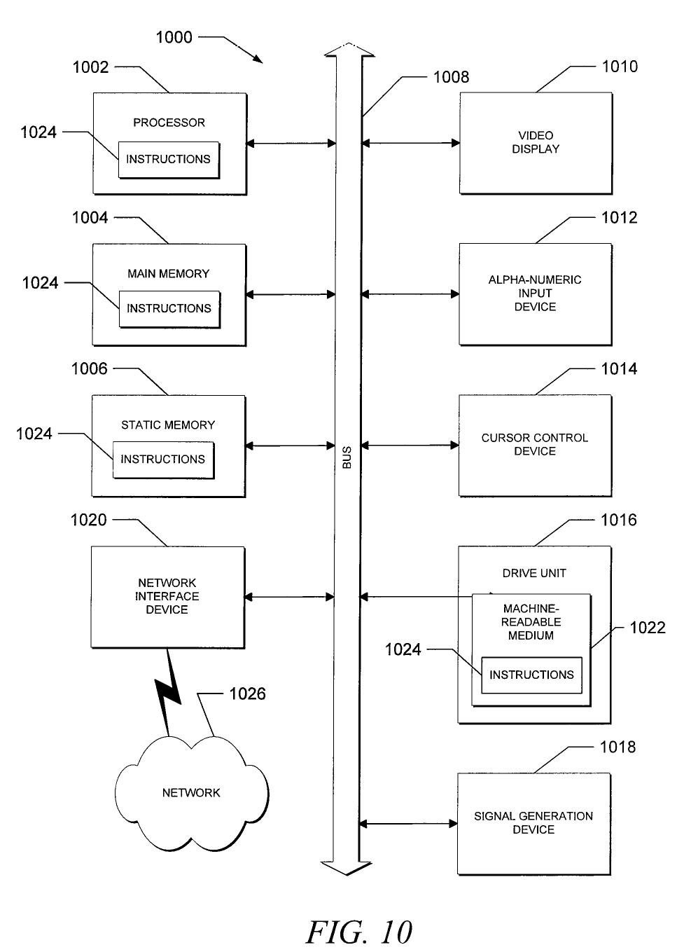

FIG. 10 is a simplified block diagram of a machine in the example form of a computing system within which a set of instructions, for causing the machine to perform any one or more of the methodologies discussed herein, may be executed. In alternative embodiments, the machine may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a Personal Digital Assistant (PDA), a cellular telephone, a web appliance or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computing system 1000 includes processor 1002 (e.g., a central processing unit (CPU), a graphics processing unit (GPU) or both), main memory 1004 and static memory 1006, which communicate with each other via bus 1008. Computing system 1000 may further include a video display unit 1010 (e.g., a plasma display, a liquid crystal display (LCD) or a cathode ray tube (CRT)). Computing system 1000 also includes alphanumeric input device 1012 (e.g., a keyboard), user interface (UI) navigation device 1014 (e.g., a mouse), disk drive unit 1016, signal generation device 1018 (e.g., a speaker) and network interface device 1020.

Disk drive unit 1016 includes machine-readable medium 1022 on which is stored one or more sets of instructions and data structures (e.g., software 1024) embodying or utilized by any one or more of the methodologies or functions described herein. Software 1024 may also reside, completely or at least partially, within main memory 1004 and/or within the static memory 1006 and/or within processor 1002 during execution thereof by computing system 1000, with main memory 1004 and processor 1002 also constituting machine-readable tangible media. Software 1024 and/or sensor information from the sensors 102 (e.g., see FIG. 1) may further be transmitted or received over network 1026 via network interface device 1020 utilizing any one of a number of well-known transfer protocols (e.g., Hypertext Transfer Protocol (HTTP)).

While machine-readable medium 1022 is shown in an example embodiment to be a single medium, the term “machine-readable medium” should be taken to include a single medium or multiple media (e.g., a centralized or distributed database, and/or associated caches) that store the one or more sets of instructions and/or policies, and/or information such as sensor information. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, and solid-state memories, optical and magnetic media.

While the invention(s) is (are) described with reference to various implementations and exploitations, it will be understood that these embodiments are illustrative and that the scope of the invention(s) is not limited to them. In general, techniques for embedding priorities in multimedia streams may be implemented with facilities consistent with any hardware system(s) defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method comprising:
accessing sensor data, captured by a sensor monitoring a physical situation;
accessing a policy database including a plurality of policies to identify at least two lower-level policies associated with the physical situation;
accessing the policy database to identify at least one higher-level policy associated with the physical situation; and
controlling implementation of the at least two lower-level policies based on the higher-level policy.

2. The method of claim 1, wherein the at least one higher-level policy includes at least one rule identifying one or more persons authorized to access the sensor data.

3. The method of claim 1, further comprising:
generating a graphical user interface to display the at least two lower-level policies and the at least one higher-level policy;
monitoring a single user action utilizing a pointing device for selecting the higher-level policy; and
implementing the at least two lower-level policies based on the at least one higher-level policy.

4. The method of claim 1, further comprising:
generating a graphical user interface to display the at least two lower-level policies and the at least one higher-level policy;
providing an override option to allow a user to override implementation of the at least two lower-level policies; and
overriding implementation of the at least two lower-level policies based on the at least one higher-level policy upon selection of the override option.

5. The method of claim 1, wherein the plurality of policies are arranged in a hierarchical configuration wherein higher-level policies control implementation of lower-level policies.

6. The method of claim 1, further comprising:
receiving sensor data in the form of media data from a plurality of video capture devices;
storing the media data in a persistent data store; and
associating a higher-level policy with each of the plurality of video capture devices.

7. The method of claim 1, wherein the lower-level policies include a plurality of rules, each rule when implemented causing a command to be sent to an electronic device associated with the rule.

8. The method of claim 1, wherein the physical situation is a real-time event, the sensor sensing at least one activity occurring during the real-time event, the method further comprising:
accessing the policy database to identify the at least two lower-level policies which are associated with the at least one activity; and
accessing the policy database to identify the at least one higher-level policy which is associated with the at least one activity.

9. The method of claim 1, wherein the physical situation is power provided by a power source to a plurality of electronic devices in a computer network.

10. The method of claim 9, wherein the at least two lower-level policies include rules specifying allocation of power to the electronic devices.

11. The method of claim 1, wherein the at least two lower-level policies relate to prioritizing the allocation of electrical power in a computer network, prioritizing the allocation of bandwidth in the computer network, or prioritizing access of users to the computer network.

12. The method of claim 1, wherein the higher-level policy prioritizes the at least two lower-level policies based on rules associated with the higher-level policy.

13. An apparatus comprising:
a data access module to access sensor data, captured by a sensor monitoring a physical situation;
a policy access module to:
access a policy database including a plurality of policies to identify at least two lower-level policies associated with the physical situation; and
access the policy database to identify at least one higher-level policy associated with the physical situation; and
a policy engine to control implementation of the at least two lower-level policies based on the higher-level policy.

14. The apparatus of claim 13, wherein the at least one higher-level policy includes at least one rule identifying one or more persons authorized to access the sensor data.

15. The apparatus of claim 13, further comprising a user interface module configured to:
generate a graphical user interface to display the at least two lower-level policies and the at least one higher-level policy;
monitor a single user action by utilizing a pointing device for selecting the higher-level policy; and
implement the at least two lower-level policies based on the at least one higher-level policy.

16. The apparatus of claim 13, further comprising a user interface module configured to:
generate a graphical user interface to display the at least two lower-level policies and the at least one higher-level policy;
provide an override option to allow a user to override implementation of the at least two lower-level policies; and
override implementation of the at least two lower-level policies based on the at least one higher-level policy upon selection of the override option.

17. The apparatus of claim 13, wherein the plurality of policies are arranged in a hierarchical configuration wherein higher-level policies control implementation of lower-level policies.

18. The apparatus of claim 13, further comprising:
a receiver module to receive sensor data in the form of media data from a plurality of video capture devices;
a persistent data store to store the media data; and
an association module to associate the higher-level policy with each of the plurality of video capture devices.

19. The apparatus of claim 13, wherein the lower-level policies include a plurality of rules, each rule when implemented causing a command to be sent to an electronic device associated with the rule.

20. The apparatus of claim 13, wherein the physical situation is power provided by a power source to a plurality of electronic devices in a computer network.

21. An apparatus comprising:
a data access module for accessing sensor data, captured by a sensor monitoring a real-time event, to identify at least one activity occurring during the real-time event;
a policy access module for:
accessing a policy database including a plurality of policies to identify at least two lower-level policies associated with the at least one activity; and
accessing the policy database to identify at least one higher-level policy associated with the at least one activity; and
means for controlling implementation of the at least two lower-level policies based on the higher-level policy.
